(19) United States
(12) Patent Application Publication
(10) Pub. No.: US 2015/0192665 A1
(43) Pub. Date: Jul. 9, 2015

(54) METHOD AND APPARATUS OF GENERATING SIGNALS FROM MULTI-SITE RADARS USING THE SAME CHANNEL

(71) Applicants: Electronics and Telecommunications Research Institute, Daejeon (KR); Kangnam Industry-Academia Cooperation Foundation, Yongin-si Gyeonggi-do (KR)

(72) Inventors: Sun Min LIM, Daejeon (KR); Kyoung Whoan SUH, Seongnam-si Gyeonggi-do (KR); Jung Ho AHN, Seoul (KR)

(21) Appl. No.: 14/313,297

(22) Filed: Jun. 24, 2014

(30) Foreign Application Priority Data
Jan. 9, 2014 (KR) 10-2014-0002906

(51) Int. Cl. G01S 13/02

(52) U.S. Cl. CPC G01S 13/02

(57) ABSTRACT

This disclosure concerns a method and apparatus of generating a signal from multi-site radars using the same channel. This disclosure provides the method comprising generating a first signal, generating a plurality of time-shifted signals by shifting the first signal by different time shift values, computing correlation values between the first signal and the time-shifted signals, selecting second signals whose correlation values are not more than a threshold from among the time-shifted signals, in a case where two of the second signals are selected, computing a sum of correlation values for all selectable signal combinations, and selecting a signal combination that leads to a minimum sum of correlation values from among the signal combinations.

This application claims the benefit of priority of Korean Patent Application No. 10-2014-0002906 filed on Jan. 9, 2014, the entire disclosure of which is incorporated by reference herein, is claimed.

### BACKGROUND OF THE INVENTION

1. Technical Field

The present invention concerns wireless communications, and more specifically, to a method and apparatus of generating a signal from multi-site radars using the same channel.

2. Discussion of Related Art

In relation to the radar's principle, Heinrich Hertz, a German physicist, evidenced the existence of radio waves in an experiment and proved that the radio waves have a similar characteristic to light being reflected by mirror.

When it comes to application of radio waves being reflected by an object to exploring the object, this principle had been researched back in 1922 by Italian engineer Guhhelmo Marconi, and Naval Research Laboratory thereafter adopted continuous waves so as to explore ships sailing between a transmitter and a receiver using Marconi's suggestion.

The radar radiates an ultra high-frequency (UHF) wave from an antenna in a radio wave emission site, which then arrives at an airplane within a predetermined distance, receives a wave reflected by the target through an antenna, signal-processes the reflected wave, and displays the signal-processed wave on the screen, thereby measuring the direction and distance of the airplane. By the radar, the exact distance of an airplane and relative speed of a target relative of an observing site may be precisely measured.

In operation, a radar apparatus generally fires a microwave to a target and receives an electromagnetic wave reflected by the target. The received electromagnetic wave, i.e., an echo, is amplified and analyzed by a signal processor. Information on the target (e.g., distance, direction, and altitude) is typically displayed on the CRT screen, and the region scanned by radar beams is sometimes shown as a map, as if a plan position indicator (PPI) does.

There are several types of radar systems, such as a pulse radar, a CW (Continuous Wave) radar, and a light radar (lidar), and they emit different types of signals from their respective transmitters while also using different features on their reception sides. Among others, the pulse radar is presently mostly used.

In operation, a radar first induces a pulse voltage to a modulator with a trigger oscillator to generate it at a predetermined cycle repeatedly, generates a powerful microwave via a magnetron through the modulator and the oscillator and emits the microwave to an air line via a wave guide. The fire count of pulse is the same as the trigger oscillator's pulse repetition frequency and the pulse is continuously fired.

When a reflected wave comes back, the radar receives the wave through the air line, amplifies it and transfers it to a CRT (Cathode Ray Tube). A saw-tooth-wave looking current, which is driven by a trigger oscillator, is rendered to flow through a CRT deflecting coil so that the position of the target is displayed with the distance and direction as a bright dot.

The CW (Continuous Wave) radar transmits and receives a sinusoidal wave by a duplexer using the same antenna in a transmitter and a receiver and does not employ pulse modulation (PM). The CW radar lacks the capability of measuring distance by a pure sinusoidal wave and thus adopts repetitive frequency modulation in many cases. This scheme is known as FMCW (Frequency Modulation Continuous Wave) radar.

The FMCW radar, after firing an electromagnetic wave to a target, mixes an echo reflected by the target with part of the transmission frequency and meters the bit frequency, thereby measuring the distance between the target and the radar. The FMCW radar is typically used in a tide gauge or water level meter in an altimeter tank of an airplane. In this case, the FMCW radar sends out a transmission signal through an antenna while periodically and repeatedly changing the frequency of the signal. The frequency of an echoed signal has a different value from that of the wave radiated from the transmitter. The FMCW radar, when being aware of the ratio in which the frequency is changed over time, may measure the distance between the radar and the target based on the difference in frequency between transmission and reception.

Further, a microwave remote sensor is used to measure scattering coefficients of various targets installed mainly on the land. However, in case this is used as a scatter meter, it should meter scattering from the target while simultaneously on distance measuring.

The multi-function radar which is used in surface-to-air missile business needs to be capable of functions such as air target exploring, tracing, and warfare and should generate a fine waveform in order to minimize distance and speed errors. For these purposes, the waveform generator in the multi-function radar should hold functions for precise waveform generation and diagnosis of generated waveforms. Among the waveforms generated by the waveform generator in the multi-function radar are LFM (Linear Frequency Modulation), PCM (Phase Code Modulation), PT (Pulse Train), FSK (Frequency Shift Keying), LFM-PT (Linear Frequency Modulation-Pulse Train). The multi-function radar has a function of diagnosing each of the generated waveforms so as to guarantee accuracy of the waveform generation.

In case two or more radars are simultaneously operated, the radars are powered on at the same, and failure to sync may cause interference.

In order to suppress interference between the two or more radars, a conventional simplest way is time-domain multiplexing. In this scheme, some radars share time over a single band. In other words, the frequency transmitted from one radar at a given time is temporally shared on a sync-type basis. Two types of time multiplexing exist. One is station sequencing, and the other is pulse-to-pulse interleaving. However, such methods reduce the whole energy radiated from each radar, thus decreasing the signal-to-noise ratio. Accordingly, the maximum detection distance or data quality may be reduced.

Another method is to space inter-radar transmission frequencies taking into account the bandwidth considering detection distance. As the number of radars increase, the occupied bandwidth also increases as compared with the single channel, but unlike the existing time domain multiplexing, detection distance or data quality is not deteriorated.

Still another method is to bring inter-waveform independency up to a per-radar transmission waveform. This scheme requires pulses sent by other users to be encoded with a specific code in order to minimize inter-user interference, like the PN code in CDMA. For this, a certain code whose independency is maintained needs to be assigned to each user or radar system. Use of this scheme may raise computation complexity but may prevent a deterioration of detection distance or data quality, as well as an increase in occupied bandwidth.

### SUMMARY OF THE INVENTION

An object of the present invention is to provide a method and apparatus of generating radar waveforms that exhibit less inter-radar interference.

Another object of the present invention is to provide a method and system for using a number of radars on a single channel in case the transmission waveform from the radar system is subjected to frequency modulation.

According to an aspect of the present invention, there is provided a method of generating a signal from multi-site radars using the same channel. The method comprises generating a first signal, generating a plurality of time-shifted signals by shifting the first signal by different time shift values, computing correlation values between the first signal and the time-shifted signals, selecting second signals whose correlation values are not more than a threshold from among the time-shifted signals, in a case where two of the second signals are selected, computing a sum of correlation values for all selectable signal combinations, and selecting a signal combination that leads to a minimum sum of correlation values from among the signal combinations.

In another aspect, the method may further comprise computing a sum of correlation values for all selectable signal combinations and selecting a signal combination that allows the sum of correlation values to be minimized from the signal combinations.

In another aspect, the method may further comprise assigning the second signals to a plurality of radars.

In another aspect, the number of the selected second signals may be the same as the number of the plurality of radars.

In another aspect, the first signal may be a chirp pulse signal.

In another aspect, the first signal may be an FMCW (frequency modulation continuous wave) signal.

In another aspect, the signals constituting the signal combinations may mutually share a frequency band.

In another aspect, the signals constituting the signal combinations may share the same channel.

In another aspect, the time shift values may be within a predetermined range depending on a minor lobe of a signal and the number of necessary signals.

According to another aspect of the present invention, there is provided an apparatus of generating a signal from multi-site radars using the same channel. The apparatus comprises a signal generating unit generating a first signal and a plurality of time-shifted signals by shifting the first signal by different time shift values, a correlation value computing unit computing correlation values between the first signal and the time-shifted signals, a signal selecting unit selecting second signals whose correlation values are not more than a threshold from among the time-shifted signals, a correlation value summing unit, in a case where two of the second signals are selected, computing a sum of correlation values for all selectable signal combinations, and a signal combining unit selecting a signal combination that leads to a minimum sum of correlation values from among the signal combinations.

In another aspect, the apparatus may further comprise a signal combination correlation value summing unit computing a sum of correlation values for all selectable signal combinations, in which the signal combination selecting unit may be implemented to select a signal combination that allows the sum of correlation values to be minimized from the signal combinations.

In another aspect, the apparatus may further comprise a signal assigning unit assigning the second signals to a plurality of radars.

In another aspect, the number of the selected second signals may be the same as the number of the plurality of radars.

In another aspect, the first signal may be a chirp pulse signal.

In another aspect, the first signal may be an FMCW (frequency modulation continuous wave) signal.

In another aspect, the signals constituting the signal combinations may mutually share a frequency band.

In another aspect, the signals constituting the signal combinations may share the same channel.

In another aspect, the time shift values may be within a predetermined range depending on a minor lobe of a signal and the number of necessary signals.

In accordance with a configuration of the present invention, a plurality of radars may be operated on the same channel, so that frequency use may be enhanced, thus allowing for raising efficiency in use of limited frequency resources and securing additional frequencies.

### BRIEF DESCRIPTION OF DRAWINGS

FIG. 1 is a view illustrating the concept of a radar system to which the present invention may apply;

FIG. 2 illustrates time-domain waveforms (right-hand) and an auto-correlation function for some FM (frequency modulation);

FIG. 3 illustrates a cross-correlation function obtained by shifting the FM signals of FIG. 2 by T;

FIG. 4 is a flowchart illustrating a method of generating a signal from multi-site radars using the same channel according to the present invention;

FIG. 5 is a block diagram illustrating a system of generating a signal from multi-site radars using the same channel according to the present invention;

FIGS. 6 to 8 illustrate the result of interference analysis in case N=3;

FIGS. 9 to 12 illustrate the result of interference analysis in case N=4; and

FIGS. 13 to 17 illustrate the result of interference analysis in case N=5.

### DETAILED DESCRIPTION OF EMBODIMENTS

Embodiments of the present invention are described with reference to the accompanying drawings in such a detailed manner as they can be easily embodied by one of ordinary skill in the art. However, the present invention may be embodied in other various ways, and is not limited to the embodiments herein. For enforcing clarity, the drawings exclude any part that is not related to the description of the present invention, and throughout the specification, similar reference signs refer to similar elements.

As used herein, when an element “includes” another element, the element may further include other elements without excluding the other element unless stated otherwise. Further, the term “unit” means a basis for processing at least one function or operation and this may be realized in software, hardware, or a combination thereof.

Thereafter, embodiments of the present invention are described with reference to the accompanying drawings.

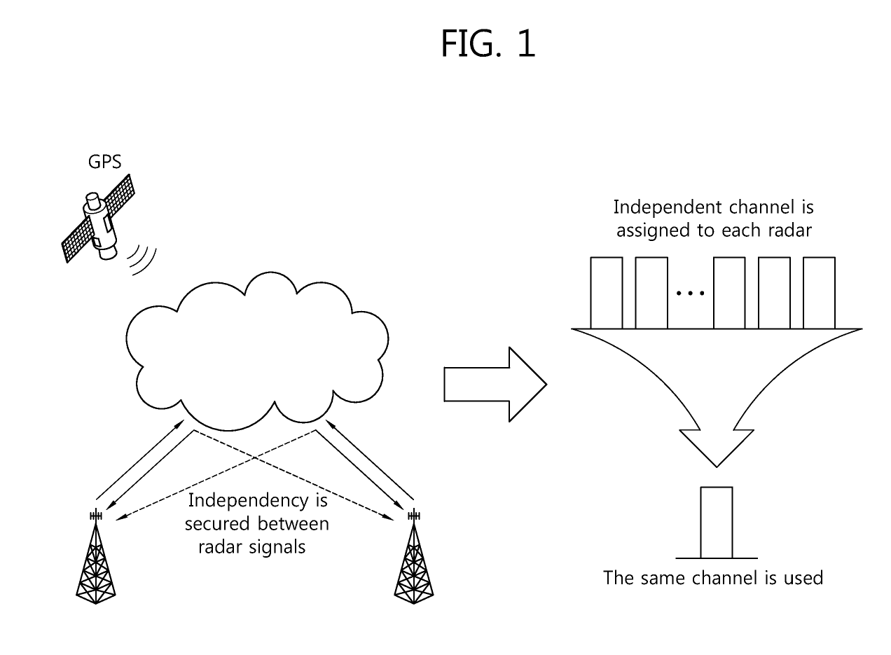

FIG. 1 illustrates the concept of a radar system to which the present invention may apply.

Although in the conventional radar systems, each of the multi-site radars having the same purpose uses an independent channel, if as a radar transmission signal a transmission waveform whose mutual interference is less than a specific threshold is selected and assigned, the multi-site radars may be operated on a single channel. Sync between the multi-site radars may be achieved by GPS, and in order for the mutual interference to have a value less than a specific threshold, inter-waveform orthogonality needs to be secured.

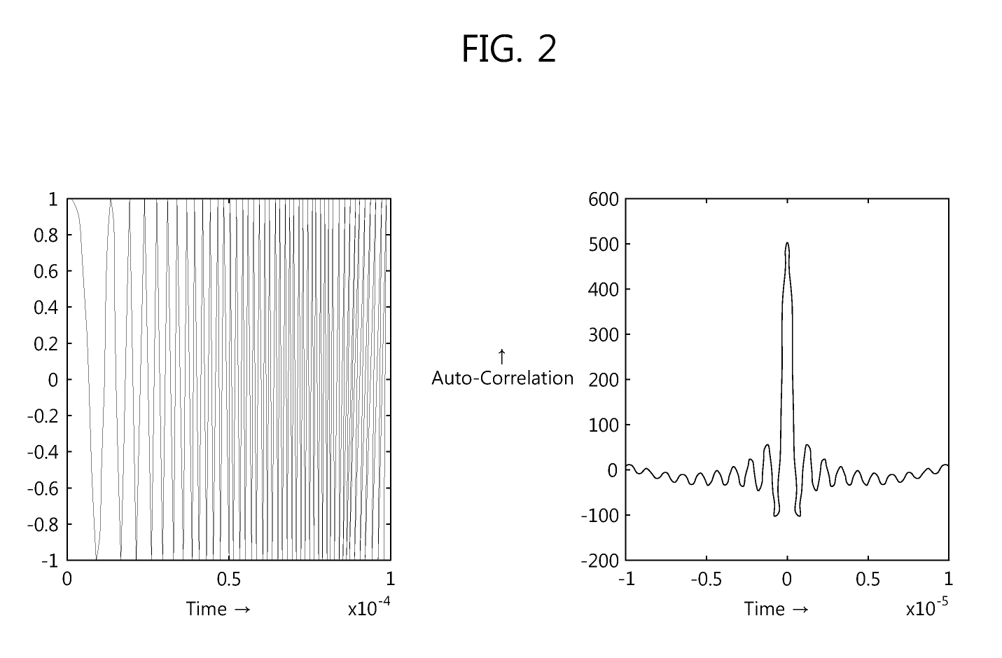

FIG. 2 illustrates time-domain waveforms (right-hand) and an auto-correlation function for some FM (frequency modulation) signal. The auto-correlation function for sweep time T of the FM waveform is represented in the form of pulses being compressed.

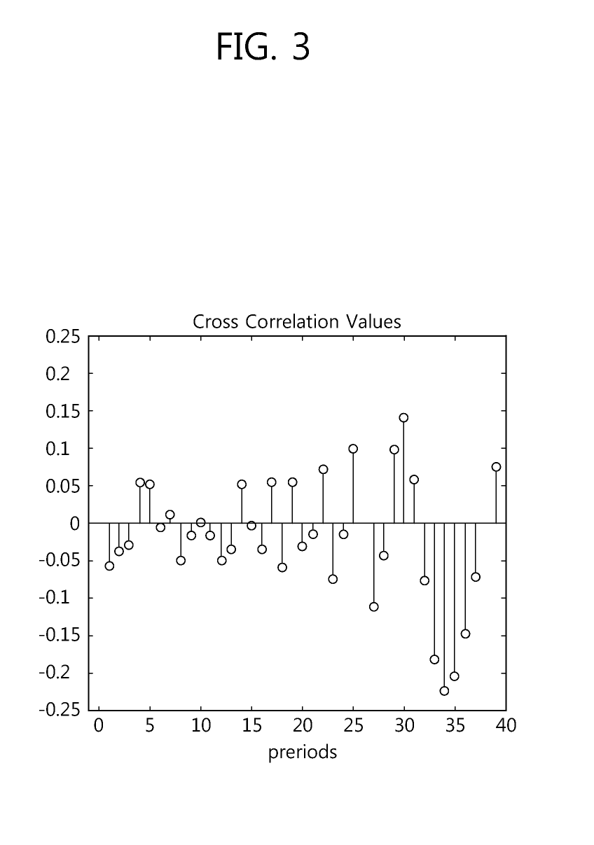

FIG. 3 illustrates an auto-correlation function obtained by shifting the FM signal of FIG. 2 by T on time axis. Referring to FIG. 3, among the auto-correlation function values shifted by T on time axis points whose values are lower than a specific value are discovered, and the time-axis values of the discovered values may be defined as T₁, T₂, T₃, . . . . The time-axis values are signals obtained by shifting a reference signal by their respective T's from T=0. Further, the FM waveforms beginning from the time-axis values may be defined as s₁(t), s₂(t), s₃(t), . . . , respectively. These signals need to satisfy the following conditions so as to have independent characteristics from those of s₀(t) that is an FM waveform at T=0.

First, independence should be maintained between reference signal s₀(t) and shifted signals. As used herein, the term “independence” means that the correlation value is a threshold or less and no or little mutual influence exists due to interference. Second, independence should be maintained between the shifted signals s₁(t), s₂(t), s₃(t), . . . . For example, independence should be maintained between s₁(t) and s₂ (t), s₃ (t), . . . , and between s₂ (t) and s₁ (t), s₃ (t), . . . .

If the above two conditions are met within a predetermined range, a plurality of radars that are clock-synced based on GPS may be simultaneously operated on the same channel by FM signals having independence. In the above conditions, the reference signal, s₀(t), preferably has an auto-correlation function waveform that is the same or substantially the same as the reference signal waveform.

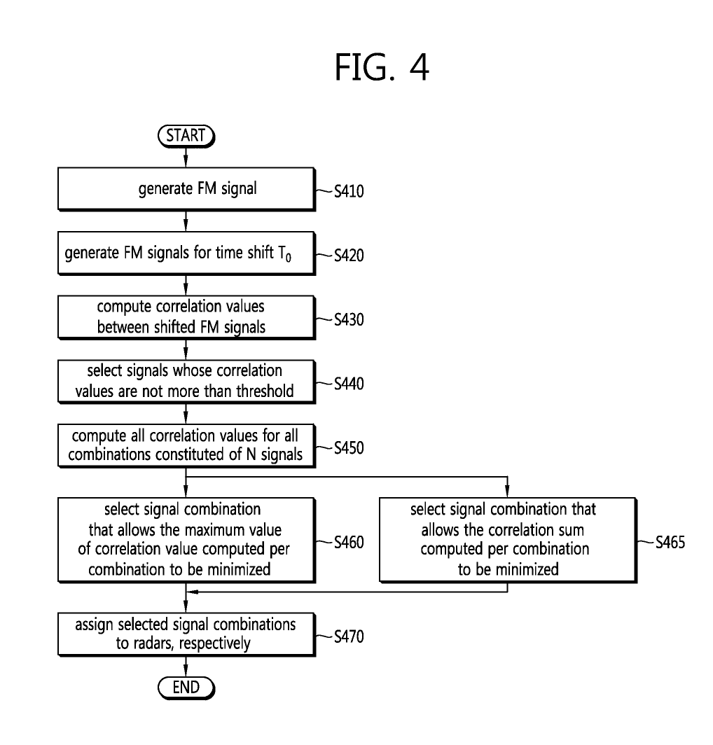

FIG. 4 is a flowchart illustrating a method of generating a signal in multi-site radars using the same channel according to the present invention.

Referring to FIG. 4, the radar signal generating apparatus first generates a reference signal (S410). The reference signal preferably has the same or substantially the same auto-correlation function waveform as an FM signal and may be a chirp signal as shown in Equation 1:

$$f ( t ) = {A}_{0} sin ( 2 π {f}_{0} t + \frac{π B}{{Tt}^{2}} ) \cdot 0 \leq t \leq T \qquad [ Equation 1 ]$$

In Equation 1, B refers to a sweep bandwidth, t a sweep time, and f₀ a carrier frequency.

Next, the radar signal generating apparatus generates an FM signal by time shifting the reference signal of Equation 1 by T₀ (S420). The time-shifted FM signal may be represented in Equation 2:

$$f ( t ; {T}_{0} ) = \{ \begin{matrix}{A}_{0} sin ( 2 π {f}_{0} ( t + {T}_{0} ) + \frac{π B}{{T ( t + {T}_{0} )}^{2}} ) , 0 \leq t \leq T - {T}_{0} \\ {A}_{0} sin ( 2 π {f}_{0} ( t - T + {T}_{0} ) + \frac{π B}{{T ( t - T + {T}_{0} )}^{2}} ) , \\ T - {T}_{0} \leq t \leq T\end{matrix} \qquad [ Equation 2 ]$$

Thereafter, the radar signal generating apparatus computes correlation values between the reference signal and time-shifted signals (S430). The correlation values may be calculated in Equation 3:

corr(f(t;0),f(t;T₀))=∫f((t;0)·f(t;T₀))dt [Equation 3]

In Equation 3, f(t;0) refers to reference signal f(t) generated in Equation 1.

The radar signal generating apparatus selects signals with correlation values being not more than a threshold among the signals whose correlation values have been computed in Equation 3 (S440). The radar signal generating apparatus may choose only the signals whose time-shifted values are within a specific range among the signals whose correlation values are not more than the threshold depending on the number of all the radars. For example, signals satisfying, T₀>τ_{L}T or T₀<τ_{U}T may be selected by adjusting τ_{L} and τ_{U} depending on the number of FM signals required and minor lobe of signals through value computation.

Then, the radar signal generating apparatus selects all possible combinations of selecting N signals necessary for allocating N radars for the signals chosen in step S440, selects each pair in each combination, and computes the correlation value of each pair (S450). The correlation value of each pair of signals may be yielded in Equation 4:

r(Tᵢ,Tⱼ)=corr(f(t;Tᵢ),f(t;Tⱼ)),i,j=0, 1, . . . , n [Equation 4]

The radar signal generating apparatus may select a signal combination in which the maximum value of the correlation value computed for each combination is minimized (S460) and may allocate the selected signal combination to each radar (S470). Further, the radar signal generating apparatus, instead of selecting a combination in which the maximum value of two correlation values selected in each combination among all the combinations constituted of N signals, may compute all correlation sums Σ corr(f(t; Tᵢ), f(t; Tⱼ)) of correlation values for two signals that may be selected in each combination, and select a signal combination that allows the correlation sum to be minimized (S465).

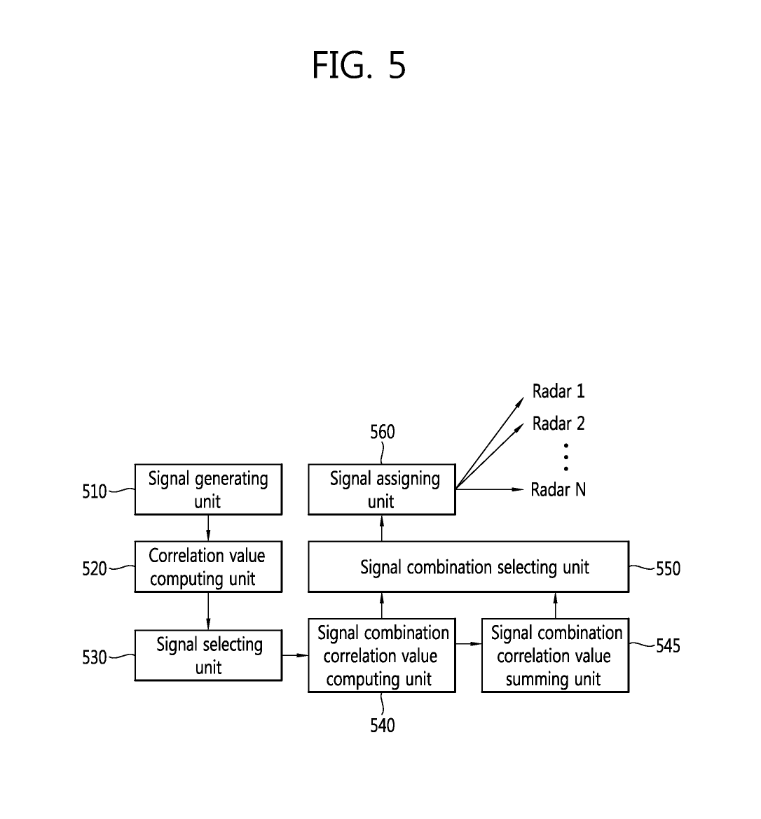

FIG. 5 is a block diagram illustrating an apparatus of generating signals from multi-site radars using the same channel according to the present invention.

Referring to FIG. 5, the radar signal generating apparatus according to the present invention may include a signal generating unit 510, a correlation value computing unit 520, a signal selecting unit 530, a signal combination correlation value computing unit 540, a signal combination correlation value summing unit 545, a signal combination selecting unit 550, and a signal assigning unit 560.

The signal generating unit 510 generates a reference signal. The reference signal preferably has an auto-correlation function waveform that is the same or similar to an FM signal and may be a chirp signal as shown in Equation 1. Further, the signal generating unit 510 generates FM signals that are obtained by time shifting the reference signal of Equation 1 by T₀. The time-shifted FM signals may be generated in Equation 2.

The correlation value computing unit 520 computes correlation values between the reference signal and time-shifted signals. The correlation values may be calculated in Equation 3. Further, the correlation value computing unit 520 may select each pair from the selected signals and may compute correlation values for the pairs. The correlation value of each pair may be calculated in Equation 4.

The signal selecting unit 530 chooses signals whose correlation values relative to the reference signal are not more than a threshold from the signals whose correlation values have been computed by the correlation value computing unit 520. The radar signal generating apparatus may select only the signals whose signal time-shifted values are within a specific range among the signals whose correlation values are not more than the threshold depending on the number of all of the radars. For example, signals satisfying, T₀>τ_{L}T or T₀<τ_{U}T may be selected by adjusting T_{L} and T_{U} depending on the number of FM signals required and minor lobe of signals through value computation.

The signal combination correlation value computing unit 540 selects all possible combinations of selecting N signals necessary for allocating N radars in the signal selecting unit 530, selects two signals in each combination, and computes a correlation value. The correlation value for the two signals may be calculated by Equation 4.

Further, the radar signal generating apparatus according to the present invention may further comprise the signal combination correlation value summing unit 545. The signal combination correlation value summing unit 545 computes a sum of the correlation values for all signal pairs that may be selected in the signal combination correlation value computing unit 540. When the signals selected in the signal selecting unit 530 are (T₁, . . . , T_{N}), the sum of correlation values for all possible signal pairs (T₁, T₂), (T₁, T₃), . . . , (T_{N-1}, T_{N}) may be represented as Σr(Tᵢ,Tⱼ).

The signal combination selecting unit 550 selects a signal combination that minimizes the sum of the maximum correlation value of all possible signals computed in the signal combination correlation value computing unit 540. When the signals selected in the signal selecting unit 530 are (T₁, . . . , T_{N}), the maximum correlation value for all possible signal pairs may be represented as max[r(Tᵢ,Tⱼ)]. At this time, the signal combination that allows the maximum correlation value to be minimized may be considered to include signals that cause less interference between output signals of the receiver.

Further, in case the radar signal generating apparatus according to the present invention includes the signal combination correlation value summing unit 545, the signal combination selecting unit 550 may select a signal combination that leads to the sum of correlation values computed in the signal combination correlation value summing unit 545 being minimized. At this time, the signal combination that results in the sum of the correlation values being minimized may be considered to have signals that generate less interference between output signals of the receiver.

The signal assigning unit 560 allocates the selected signal combination to each radar.

### EMBODIMENTS

Hereinafter, embodiments of the present invention are described to further clarify the effects of the present invention. However, the present invention is not limited to the embodiments.

Table 1 summarizes radars and environment parameters used in the computation tests according to the following embodiments.

TABLE 1

| Variables | Values | Remarks |
|---|---|---|
| N | 3, 4, 5 | No of radars |
| R1 | 100 m | Distance between radar 1 and object |
| R2 | 200 m | Distance between radar 2 and object |
| R3 | 300 m | Distance between radar 3 and object |
| R4 | 400 m | Distance between radar 4 and object |
| R5 | 500 m | Distance between radar 5 and object |
| Maximum | 1 km | |
| distance | | |
| (Dₘₐₓ) | | |
| Sweep time T | 0.01 sec | $T \geq \frac{2 {D}_{max}}{{c}_{0}} , T \text{:} sweep time$ |
| bandwidth, | 10 MHz | |
| B | (1 × 10⁷ Hz) | |
| slope, | 10⁹ | |
| B/T | | |
| f₀ | 0 | FM start frequency |
| fₘₐₓ | 6.666 | 2BDₘₐₓ/(cT) |
| | 7 × 10³ | |
| Sampling | 10⁷ | |
| rate, | | |
| fₛ | | |
| Reflection | 1 | Same for all radars |
| rate | | |
| (amplitude), A₀ | | |

Referring to Table 1, the maximum exploration distance of a radar is set as 1 km, and the FM bandwidth is set to the level of a channel bandwidth applied to the weather radar. As an example, assuming that the specific threshold is 10⁻⁸ and T_{L} and T_{U} are 0.00076 and 0.03, respectively, the number of the time-shifted FM signals obtained in step S440 is 64, and the number of combinations of methods of selecting signals from five radars among a total of 65 signals including the initial FM signal is 8,259,888 (=₆₅C₅).

The result of computation obtained by applying the variables of Table 1 to a method of generating multi-site radar signals according to the present invention has been described in connection with embodiments 1 to 3. In embodiments 1 to 3, the reference radar means a receiver that is a target for detection, and the remaining radars operate as interference sources on the same channel. In embodiments 1 to 3, N shifted FM signals having a small correlation are selected depending on the given number of radars, and the signals are assigned to their corresponding ones of the N radars on the same channel and at the same time. The result of analysis of interference is shown in embodiments 1 to 3. Since the signal bandwidth is 10 MHz, the range resolution is 15 m. The minor lobe is overall small, but the width of the main lobe that is reflection of the target appears to be relatively large. However, since the resolution is generally determined based on two points that correspond to −3 dB of the main lobe, the range resolution may be seen to be very appropriate.

### Embodiment 1

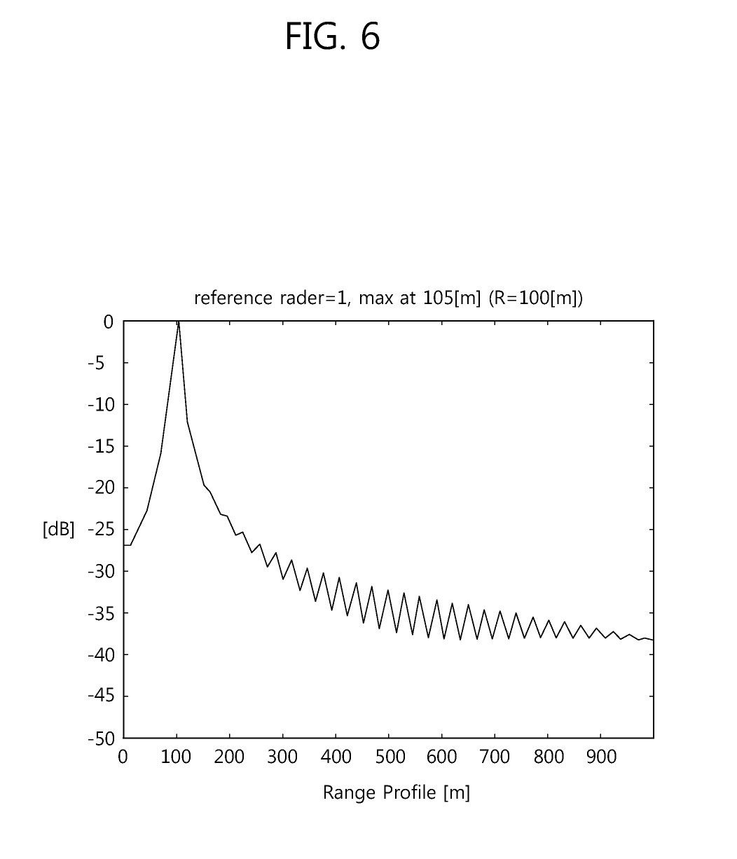

FIGS. 6 to 8 show the result of interference analysis in case N=3. FIG. 6 shows the result when radar 1 is the reference receiver. Referring to Table 1, it can be seen that a desired target is set to be 100 m away from radar 1. Under the assumption where the present invention does not apply, since the respective targets of radar 2 and radar 3 are set to be away therefrom by 200 m and 300 m, respectively, the targets of the interference sources, in addition to the target 100 m, should be present at 150 m(=(100+200)/2) and 200 m(=(100+300)/2). However, it can be seen from FIG. 6 that the interference sources are eliminated by a multi-site radar signal generating method according to the present invention.

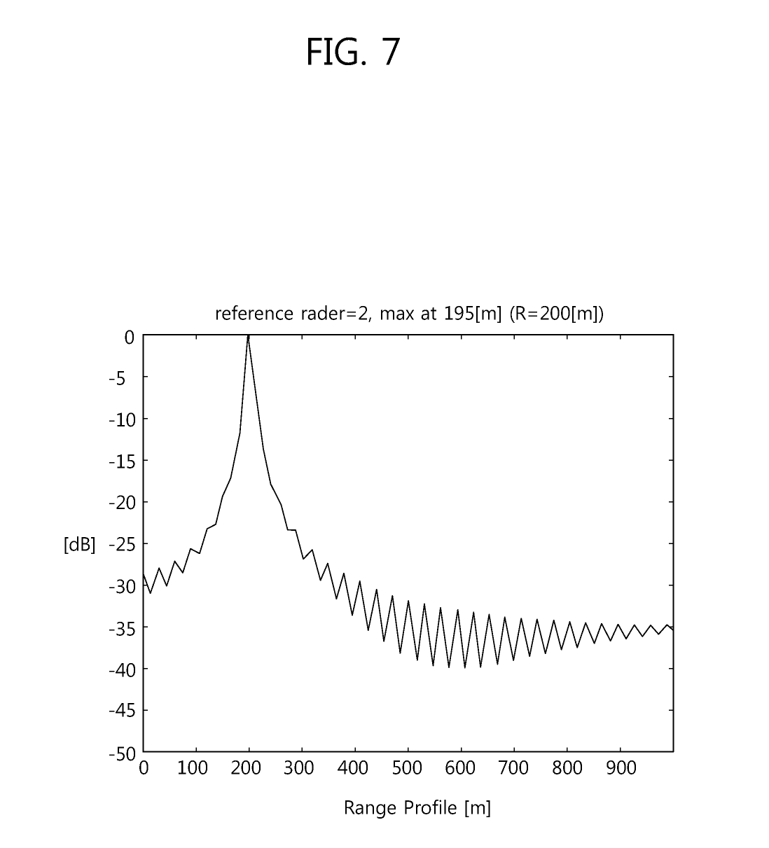

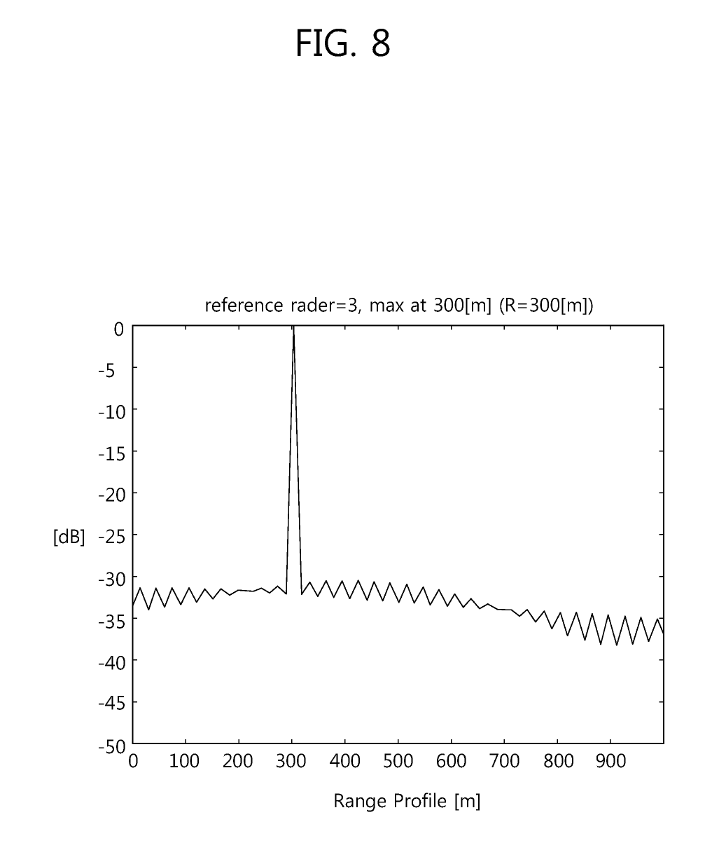

FIG. 7 shows a simulation result when radar 2 is the reference receiver while radars 1 and 3 are interference sources, and FIG. 8 shows a simulation result when radar 3 is the reference receiver while radars 1 and 2 are interference sources. Referring to FIGS. 7 and 8, the interference source except the target that is 200 m away from radar 2 and the interference source except the target that is 300 m away from radar 3 are all removed according to the present invention.

Referring to FIG. 8, since there is a target that is 300 m away from radar 3, it corresponds to an integer multiple (20) of the range resolution, and thus, the width of the main lobe is very excellent.

### Embodiment 2

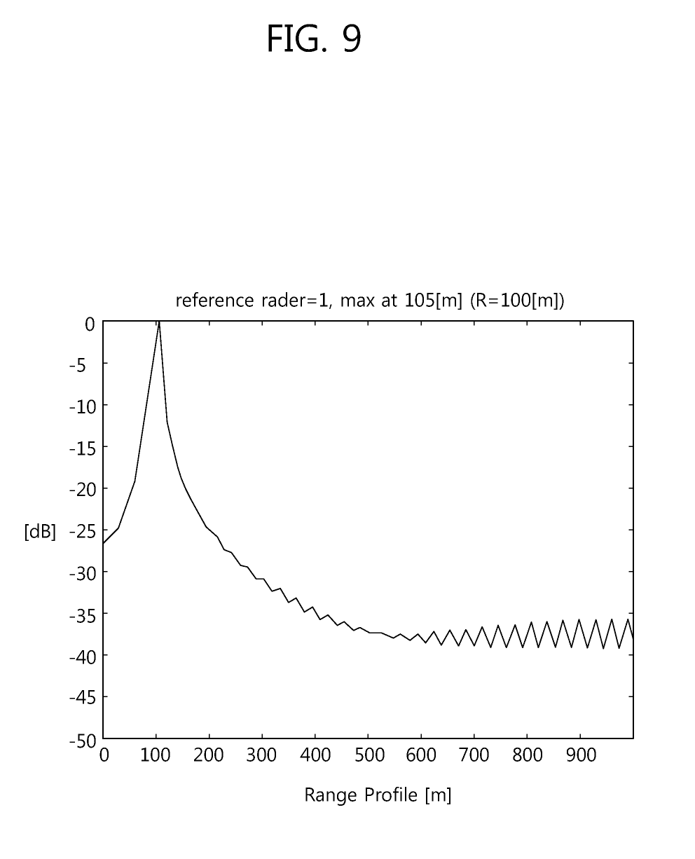

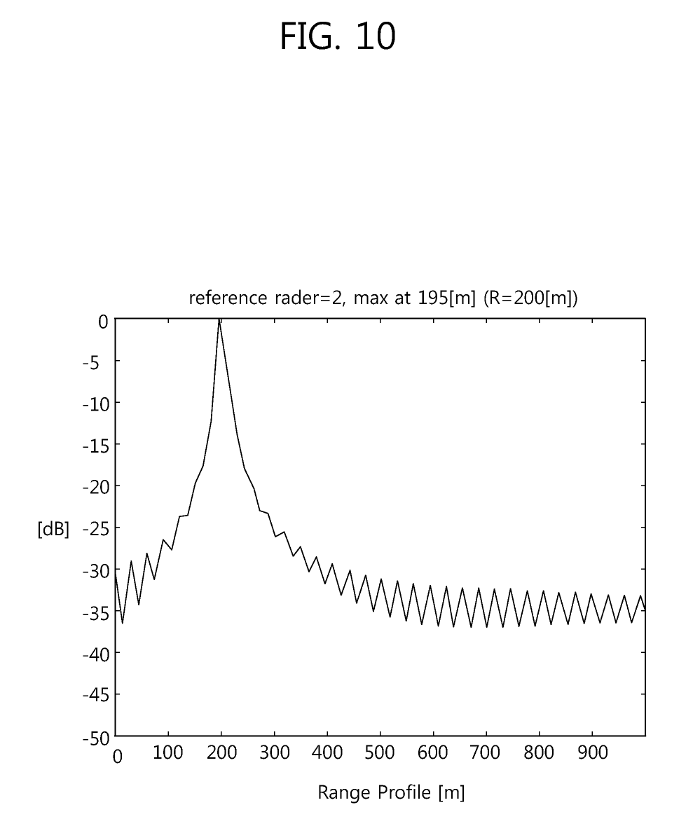

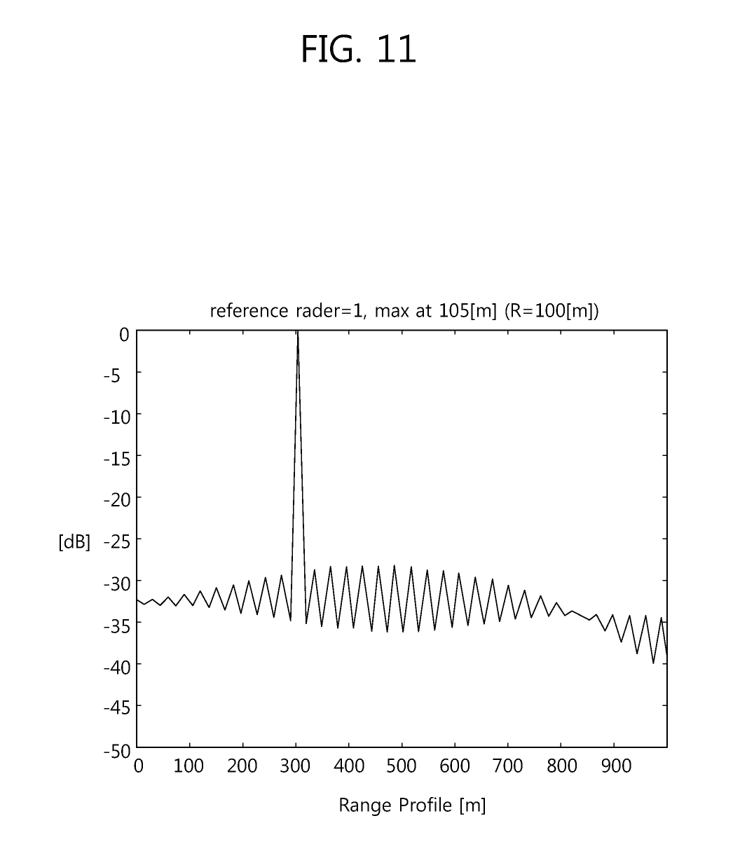

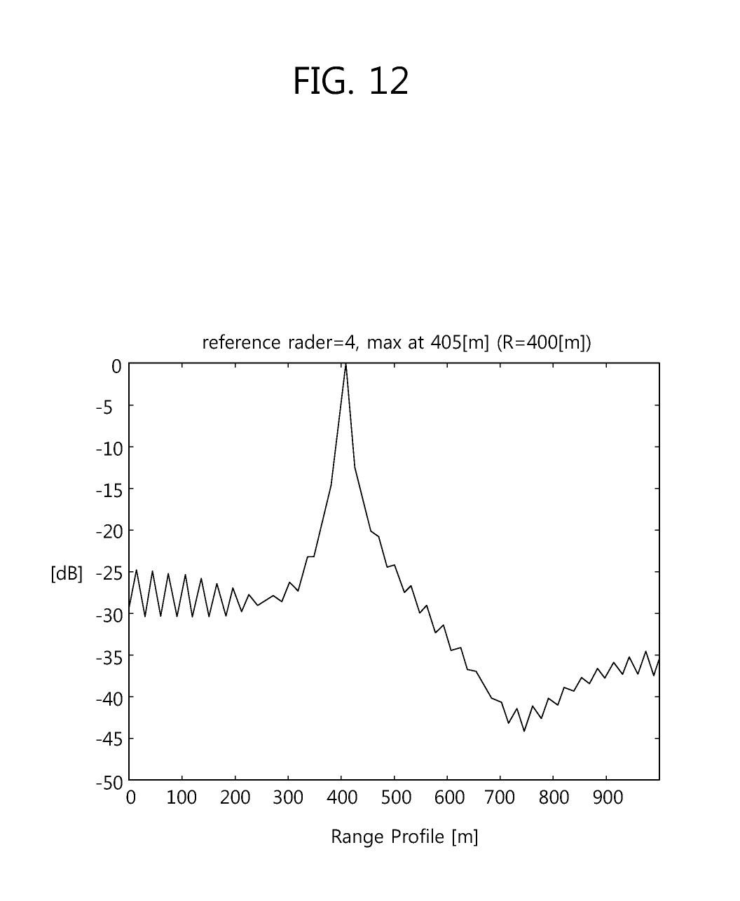

FIGS. 9 to 12 illustrate the result of interference analysis in case N=4. In embodiment 2, four shifted FM signals having small correlation are chosen according to the present invention and are respectively assigned to four radar stations.

In FIGS. 9 to 12, a simulation result is shown in case radars 1 to 4 are reference receivers, and the remaining four radars are interference sources.

The simulation result in embodiment 2 is consistent with the simulation result in embodiment 1 and the same interpretation applies in physical meaning.

### Embodiment 3

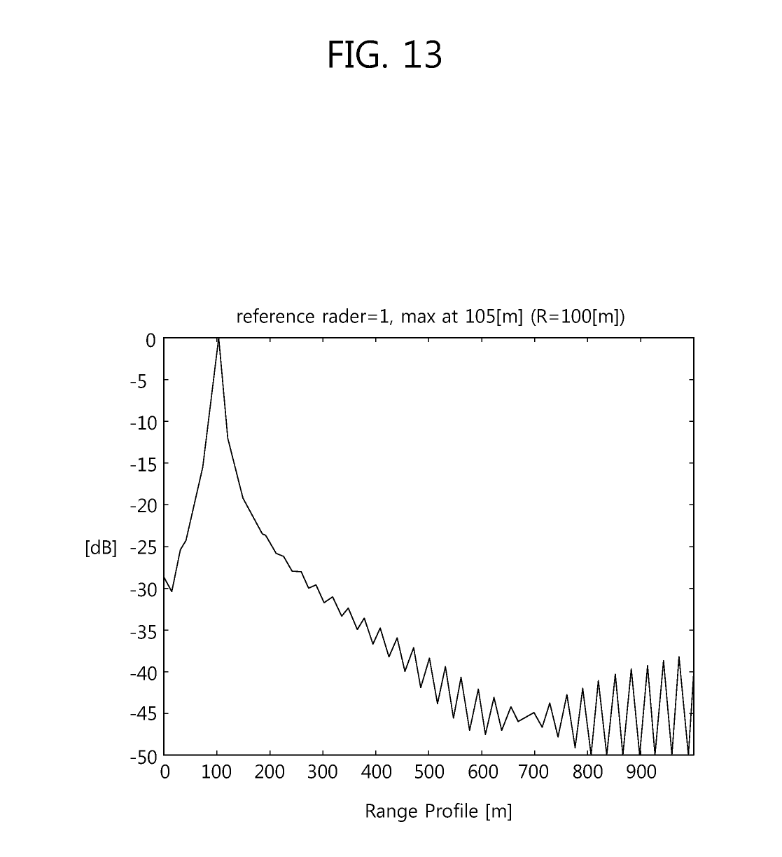

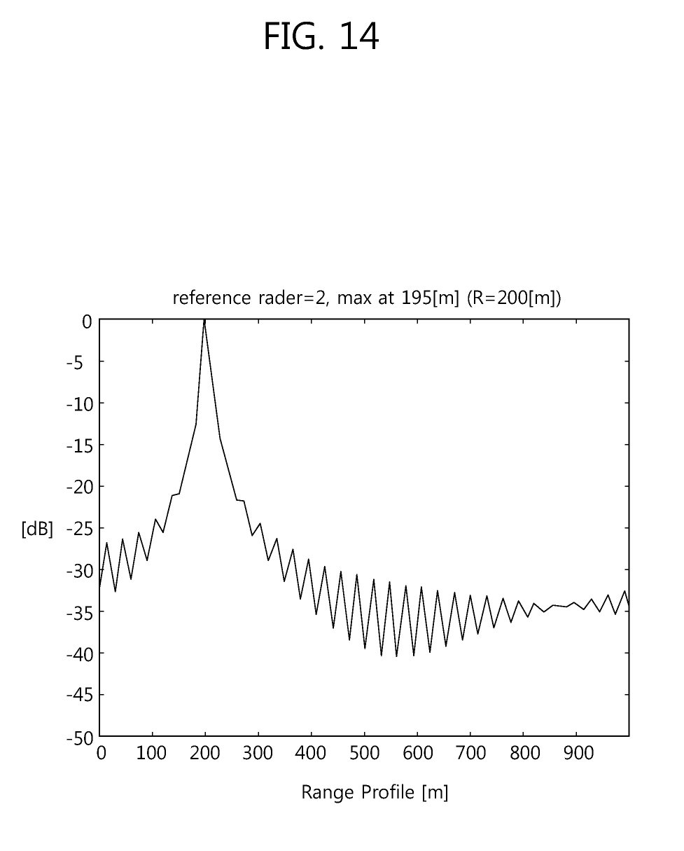

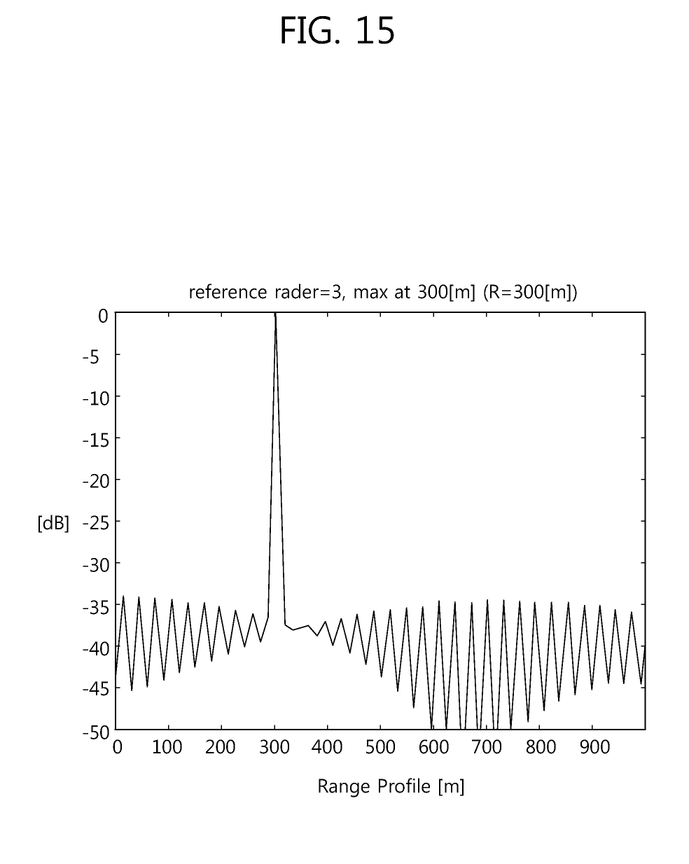

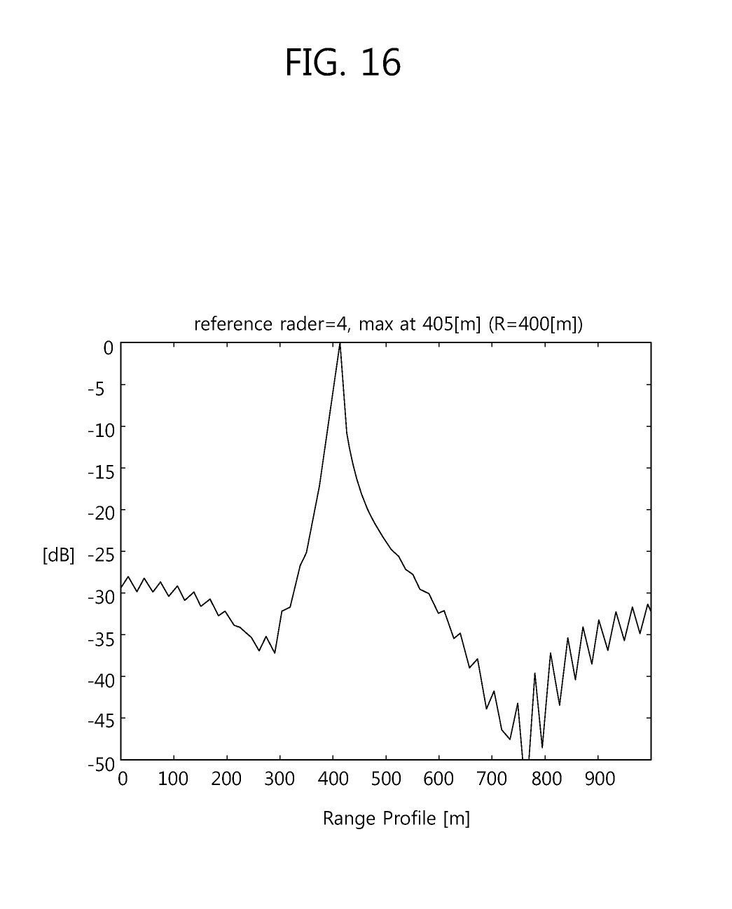

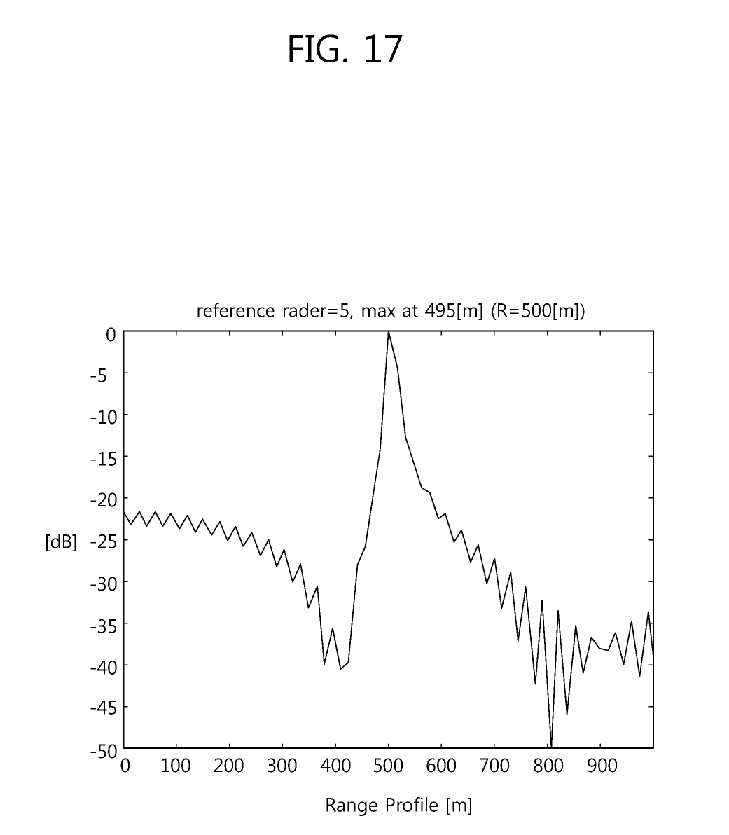

FIGS. 13 to 17 illustrate the result of interference analysis in case N=5. Five shifted FM signals with small correlation are picked up and are respectively assigned to five radar stations.

In FIGS. 13 to 17, a simulation result is shown in case radars 1 to 5 are reference receivers, and the remaining five radars are interference sources.

The simulation result in embodiment 2 is consistent with the simulation result in embodiment 1 and the same interpretation applies in physical meaning.

Summarizing the results obtained from embodiments 1 to 3, the minor lobes are all −20 dB or less, and the actual distances to the targets comply with the computed result. Further, the distance resolution relies on bandwidth. Herein, 10 MHz applies so that a resolution of 15 m is provided. If two points which become −3 dB of the main lobe are used physically as reference, consistency may be almost achieved. Table 2 shows changes in the minor lobe depending on the number (N) of waveforms having independency. Referring to Table 2, as the number (N) of the waveforms having independency increases, the minor lobe gradually increases, but has little influence.

TABLE 2

| Number (N) of shifted FM signals | |
|---|---|
| having small correlation (no of radars | Size of minor lobe relative to main |
| applied) | lobe (dB) |
| 3 | −23.50 dB |
| 4 | −23.13 dB |
| 5 | −21.49 dB |

The multi-site radar signal generating method and apparatus using the same channel according to the present invention may be applicable to all kinds of radars that adopt the FM (frequency modulation) scheme such as FMCW (frequency modulation continuous wave) radars or chirp pulse radars.

According to a configuration of the present invention, a plurality of radars are operated using the same channel, so that frequency use may be enhanced. Accordingly, limited frequency resources may be efficiently used, and additional frequencies may be secured.

Although the present invention has been shown and described with reference to some embodiments thereof, it is apparent to one of ordinary skill in the art that various changes in form and detail may be made thereto without departing from the scope of the present invention defined by the following claims.

What is claimed is:

1. A method of generating a signal from multi-site radars using the same channel, the method comprising:
generating a first signal;
generating a plurality of time-shifted signals by shifting the first signal by different time shift values;
computing correlation values between the first signal and the time-shifted signals;
selecting second signals whose correlation values are not more than a threshold from among the time-shifted signals;
computing N combinations necessary for allocating N radars in a set of the second signals;
selecting all pairs of signals that may be selected in each combination and computing a correlation value; and
selecting a signal combination that allows a maximum value of the correlation value computed in each combination to be minimized among the signal combinations.

2. The method of claim 1, further comprising:
computing a sum of correlation values for all selectable signal combinations; and
selecting a signal combination that allows the sum of correlation values to be minimized from among the signal combinations.

3. The method of claim 1, further comprising assigning the second signals to a plurality of radars.

4. The method of claim 3, wherein the number of the selected second signals is the same as the number of the plurality of radars.

5. The method of claim 1, wherein the first signal is a chirp pulse signal.

6. The method of claim 1, wherein the first signal is an FMCW (frequency modulation continuous wave) signal.

7. The method of claim 1, wherein the signals constituting the signal combinations mutually share a frequency band.

8. The method of claim 1, wherein the signals constituting the signal combinations share the same channel.

9. The method of claim 1, wherein the time shift values are within a predetermined range depending on a minor lobe of a signal and the number of necessary signals.

10. An apparatus of generating a signal from multi-site radars using the same channel, the apparatus comprising:
a signal generating unit generating a first signal and a plurality of time-shifted signals by shifting the first signal by different time shift values;
a correlation value computing unit computing correlation values between the first signal and the time-shifted signals;
a signal selecting unit selecting second signals whose correlation values are not more than a threshold from among the time-shifted signals;
a signal combination correlation value computing unit computing N combinations necessary for allocating N radars in a set of the second signals, selecting any two signals in each combination consisting of the N signals, and computing a correlation value; and
a signal combination selecting unit selecting a signal combination that allows a maximum correlation value to be minimized among the signal combinations.

11. The apparatus of claim 10, further comprising a signal combination correlation value summing unit computing a sum of correlation values for all selectable signal combinations, wherein the signal combination selecting unit selects a signal combination that allows the sum of the correlation values to be minimized among the signal combinations.

12. The apparatus of claim 10, further comprising a signal assigning unit assigning the second signals to a plurality of radars.

13. The apparatus of claim 12, wherein the number of the selected second signals is the same as the number of the plurality of radars.

14. The apparatus of claim 10, wherein the first signal is a chirp pulse signal.

15. The apparatus of claim 10, wherein the first signal is an FMCW (frequency modulation continuous wave) signal.

16. The apparatus of claim 10, wherein the signals constituting the signal combinations mutually share a frequency band.

17. The apparatus of claim 10, wherein the signals constituting the signal combinations share the same channel.

18. The apparatus of claim 10, wherein the time shift values are within a predetermined range depending on a minor lobe of a signal and the number of necessary signals.
